(19) United States
(12) Patent Application Publication
(10) Pub. No.: US 2020/0001717 A1
(43) Pub. Date: Jan. 2, 2020

(54) DISPLAY DEVICE

(71) Applicant: NIPPON SEIKI CO., LTD., Niigata (JP)

(72) Inventors: Hitoshi TAKANO, Niigata (JP); Nanhei RAI, Niigata (JP)

(21) Appl. No.: 16/490,390

(22) PCT Filed: Mar. 2, 2018
(86) PCT No.: PCT/JP2018/007919

§ 371 Date: Aug. 30, 2019

(30) Foreign Application Priority Data
Mar. 6, 2017 (JP) 2017-041289

(51) Int. Cl. B60K 35/00; G01D 13/04; G01D 11/28

(52) U.S. Cl. CPC B60K 35/00; G01D 11/28; G01D 13/04

(57) ABSTRACT

The objective of the present invention is to provide a display device having an external appearance which is improved by eliminating a print step on a dial plate inside which a liquid crystal panel is disposed. In a display device 1 provided with a liquid crystal panel 3 including a display portion 31, and a dial plate 2 disposed on a front side of the liquid crystal panel 3, the dial plate 2 includes a transparent substrate 21, a first protective layer 22 formed on a front surface of the transparent substrate 21, and a second protective layer 23 formed on a front surface of the first protective layer 22. The second protective layer 23 of the dial plate 2 includes a first opening portion 23a in a position corresponding to the display portion 31, and a gradation portion 23b having a gradation which becomes thinner toward the inside of the first opening portion 23a.

### TECHNICAL FIELD

The present invention relates to a display device (so called a meter) for a vehicle, in which a liquid crystal panel is placed inside a dial plate.

### BACKGROUND ART

Conventionally, in this type of display device, a display device for a vehicle has been put into practical use, in which a liquid crystal panel is placed in the display device of a vehicle, and vehicle information such as fuel consumption information, travel distance information and various warning information is centrally displayed in the liquid crystal panel.

As illustrated in FIG. 4, a display device disclosed in Patent Document 1 includes a dial plate 9 made of a transparent substrate 91 and a liquid crystal panel 10 disposed on the back surface side of the dial plate 9. A light shielding black printing layer 92 having an opening portion 92a, in which the liquid crystal panel 10 is visible, a meter scale (not illustrated) and a warning lamp (not illustrated) is formed on the front surface of the transparent substrate 91, and a matte printing layer 93 is formed at a position corresponding to the inner side of the opening portion 92a, and a hard coat layer 94 is formed on the front surfaces of the matte printing layer 93 and the black printing layer 92 and a smoke printing layer 95 is formed at a position corresponding to the opening portion 92a on the back surface of the transparent substrate 91, and information displayed on the liquid crystal panel 10 is visually recognized through the opening portion 92a.

Then, the black printing layer 92 contains a matte material, and is matched in the degree of matte with the above-mentioned matte printing layer 93. Therefore, it is known that the degree of haze of the matte printing layer 93 and the black printing layer 92 is uniformed.

### PRIOR ART DOCUMENT

### Patent Document

Patent Document 1: Japanese Unexamined Patent Application Publication No. 2016-156653

### SUMMARY OF THE INVENTION

### Problems to be Solved by the Invention

However, in such a display device, when the hard coat layer 94 is provided on the front surface of the matte printing layer 93, there is a problem in that the effect of reducing front reflection when external light is incident on the matte printing layer 93 is impaired.

As one measure against the above problem, for example, a hard coat opening 94a in which the hard coat layer 93 is not formed on the front surface of the matte printing layer 93 may be provided, but it is necessary to consider manufacturing deviation of printing of each layer. Then, since it is necessary to form the boundary portion between the black printing layer 92 and the matte printing layer 93 and the boundary portion between the matte printing layer 93 and the hard coat layer 94 in an overlapping manner, there is a problem that a step is occurred at the respective portions, and a flat feeling on the front surface of the dial plate 9 is impaired.

Therefore, an object of the present invention is to provide a display device which is made in view of the above problem and which eliminates a print step on a dial plate inside which a liquid crystal panel is disposed and improves a visual quality of an external appearance.

### Solution to Problem

In order to achieve the object, a display device 1 according to the present invention includes a liquid crystal panel 3 including a display portion 31, and a dial plate 2 placed on a front side of the liquid crystal panel 3, the dial plate 2 includes a transparent substrate 21, a first protective layer 22 formed on a front surface of the transparent substrate 21, and a second protective layer 23 formed on a front surface of the first protective layer 22, and the second protective layer 23 includes a first opening portion 23a at a position corresponding to the display portion 31, and a gradation portion 23b in which gradation becomes thinner toward an inside of the first opening portion 23a.

The dial plate 2 includes a light shielding layer 24 including a second opening portion 24a at a position corresponding to the display portion 31 on a back surface side of the first protective layer 22, and the gradation portion 23b is formed across a position corresponding to the second opening portion 24a.

Further, the light shielding layer 24 is formed on a back surface side of the transparent substrate 21.

Further, a colored layer 25 is provided at a position corresponding to the first opening portion 23a.

Also, a degree of haze of the first protective layer 22 is lower than that of the second protective layer 23.

### Effect of the Invention

The present invention can provide a display device which eliminates the print step on the dial plate inside which the liquid crystal panel is disposed and improves the visual quality of the external appearance.

### BRIEF DESCRIPTION OF THE DRAWINGS

FIG. 1 is a schematic plan view of a display device 1 according to a first embodiment of the present invention.

FIG. 2 is a cross-sectional view taken along the line A-A illustrated in FIG. 1.

FIG. 3 is an enlarged view of the main portion Z of FIG. 2.

FIG. 4 is a view illustrating a conventional cross-sectional structure.

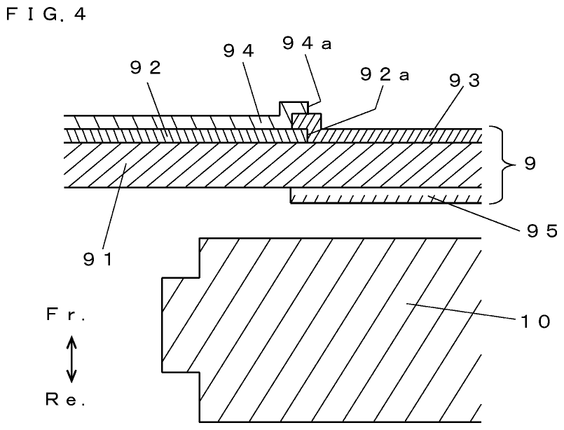

### MODE FOR CARRYING OUT THE INVENTION

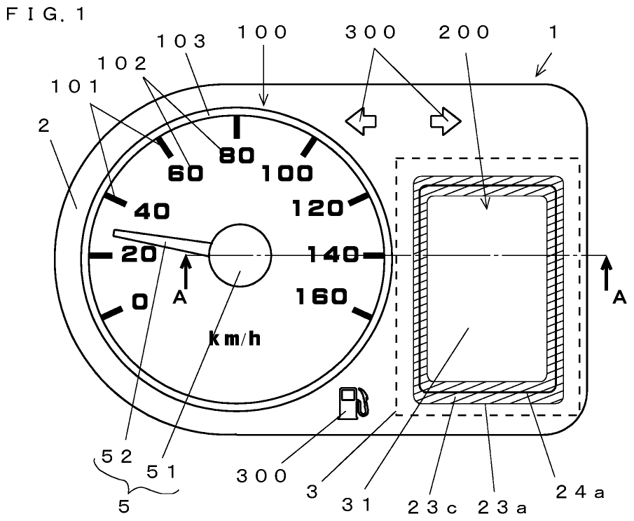

A first embodiment of the present invention will now be described with reference to FIGS. 1 to 3. Moreover, the front and back of a display device 1 are indicated by the arrows in each figure.

As illustrated in FIG. 1, the display device 1 includes a speedometer 100 and an information display unit 200. A dial plate 2 is the one on which a plurality of scale parts 101 and an indicator part 102 corresponding the scale parts 101 are drawn in a circular interior surrounded by a decoration ring 103 arranged on the front face of the dial plate 2. The speedometer 100 is configured such that an indicator portion 52 of a pointer 5 rotating with a boss portion 53 as a support end indicates the front surface of the scale parts 101. Also, the information display unit 200 includes the dial plate 2, a liquid crystal panel 3 arranged on the back surface side of the dial plate 2, and a transparent resin layer 4 for joining the dial plate 2 and the liquid crystal panel 3, and a liquid crystal display portion 31 (display part) of the liquid crystal panel 3 described later is visibly arranged. Various types of vehicle information such as fuel consumption information, travel distance information, warning information, and the like, are displayed in the liquid crystal display portion 31 as necessary.

The decoration ring 103 is made of a light-shielding synthetic resin such as black ABS (acrylonitrile butadiene styrene) resin, is formed in a trapezoidal cross shape, and is coated with a silver color coating on its front surface. Also, the decoration ring 103 has a plurality of ring hooks 103a which are locked and fixed to the back surface of the dial plate 2.

The liquid crystal panel 3 includes the liquid crystal display portion 31 made of, for example, a TFT (Thin Film Transistor) type Liquid Crystal Display (LCD) for displaying the above-mentioned various kinds of vehicle information. It is noted that the liquid crystal panel 3 may be a general-purpose modularized liquid crystal display. Further, it may be an organic EL display (OLED: Organic Light Emitting Diode), or the like. Also, the liquid crystal panel 3 is backlit by a first illumination unit 62, for example, including a Light Emitting Diode (LED) which is mounted on the front surface of a circuit board 6 on the back surface of the dial plate 2.

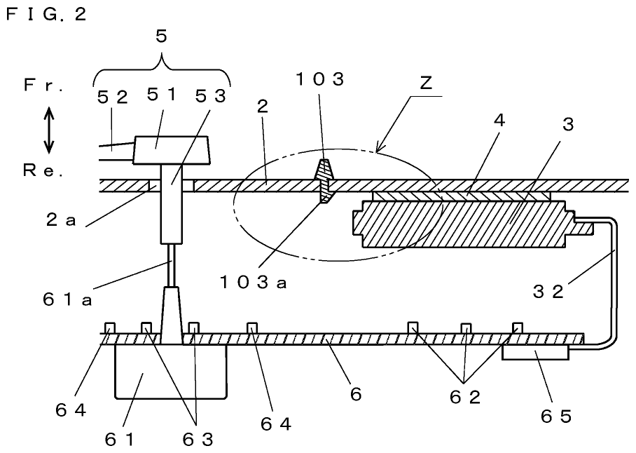

As illustrated in FIG. 2, the pointer 5 includes a cover portion 51 formed of light shielding synthetic resin such as black ABS resin, for example, in a cover shape and the indicator portion 52 made of transparent PC (polycarbonate) resin. Also, the pointer 5 rotates the front surface of the dial plate 2 so that the boss portion 53 is attached to the front end of a rotating shaft 61a extending toward the front of the circuit board 6 from a pointer driving part 61 fixed to the back surface of the circuit board 6. By being formed in this manner, the indicator portion 52 indicates the scale parts 101. Further, the pointer 5 is illuminated by a second illumination unit 63 including a light emitting diode mounted on the front surface of the circuit board 6.

The circuit board 6 includes a glass epoxy-based hard printed board such as FR-4 (Flame Retardant-4). Further, the circuit board 6 has an FPC (Flexible Printed Circuits) connector 65 on its back surface, and an FPC 32 connected to the liquid crystal panel 3 is populated to the FPC connector 65, and is energized with the liquid crystal panel 3. Further, the circuit board 6 drives and controls the pointer driving part 61, the first illumination unit 62, the second illumination unit 63, a third illumination unit 64, and the liquid crystal panel 3.

The dial plate 2 includes, for example, a transparent substrate 21 as mother material made of a transparent resin such as transparent PC resin having a flat plate shape. On the transparent substrate 21, a through hole 2a is provided, through which the boss portion 53 provided in the cover portion 51 of the pointer 5 is inserted. The liquid crystal display portion 31 is visibly placed on the back surface side of the transparent substrate 21. Further, the dial plate 2 is filled with a transparent resin layer 4 in the form of light transmitting gel between the back surface of the dial plate 2 and the front surface of the liquid crystal panel 3, and both are adhesively fixed to each other (optical bonding technology).

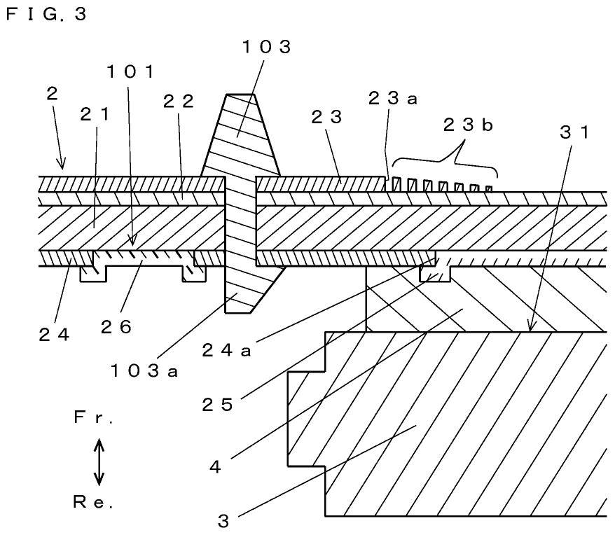

As illustrated in FIG. 3, a first matte printing layer 22 (first protective layer) is formed on the entire front surface side of the transparent substrate 21 by an ink containing high-hardness, fine particle diameter beads, which is a matte material. The first matte printing layer 22 is formed such that the degree of haze (generally referred to as a haze value and the ratio of the diffuse transmittance to the total transmittance of incident light) has a value within a predetermined range.

Also, a second matte printing layer 23 (second protective layer) is formed on the front surface of the first matte printing layer 22. The second matte printing layer 23 is also formed such that the degree of haze is within a predetermined range. The second matte printing layer 23 has a first opening portion 23a in which no second matte printing layer 23 is formed in the region corresponding to the liquid crystal display portion 31. By being formed in this manner, the front surface of the transparent substrate 21 is protected by covering the front surface of the transparent substrate 21 with the first matte printing layer 22 and the second matte printing layer 23.

The bead diameter contained in the first matte printing layer 22 is 5 μm to 10 μm, and the bead diameter contained in the second matte printing layer 23 is 15 μm to 20 μm, and is larger than that of the first matte printing layer 22, and the content in the second matte printing layer 23 is larger than that in the first matte printing layer 22. Thus, the haze value of the first matte printing layer 22 (JIS K 7361-1-testing method of the total light transmittance of plastic transparent material-first part single beam method) is set to 40 to 60, and the haze value of the second matte printing layer 23 is set to 70 to 90, which is higher than that of the first matte printing layer 22.

A black printing layer 24 (light shielding layer) having light shielding characteristic is formed on the back surface side of the transparent substrate 21. The black printing layer 24 includes the second opening portion 24a in which no black printing layer 24 is formed in the region corresponding to the display portion 31. Moreover, the black printing layer 24 is provided with various designs such as the scale parts 101, the indicator part 102 and an operation and warning lamp 300, each of which is not provided with the black printing layer 24. Further, a smoke printing layer 25 (colored layer) colored in a smoke tone for reducing transmittance is formed in the second opening portion 24a. The smoke printing layer 25 is printed as to overlap (wrap) the outer periphery with the black printing layer 24 in consideration of a deviation in the manufacturing of printing.

The scale parts 101 and the indicator part 102 are formed in an arc shape, and a white printing layer 26 having translucency is formed on the back surface of the black printing layer 24 corresponding to the scale parts 101 and the indicator part 102. The white printing layer 26 is also printed as to overlap (wrap) the outer periphery with the black printing layer 24 in consideration of a deviation in the manufacturing of printing. Further, the transmittance of the smoke printing layer 25 is set to 30% to 60% so that the appearance of the smoke printing layer 25 and the black printing layer 24 is uniform when the first illumination unit 62 is turned off.

Further, the first opening portion 23a has a gradation portion 23b in a dot shape in which the gradation becomes thinner toward the inside of the first opening portion 23a in a range of about 5 mm as to bridge the second opening portion 24a.

Hereinafter, in the dial plate 2 according to the present embodiment, the display effect in lighting the liquid crystal panel 3 and the white printing layer 26 and how the liquid crystal panel 3 is seen in not lighting and in external light being incident on the dial plate 2 will be described in order.

The display effect when the first illumination unit 62 emits illumination light (lights) will be described below. The illumination light emitted from the first illumination unit 62 illuminates the liquid crystal panel 3 with a backlight, passes the liquid crystal panel 3 at portions of the characters and figures displayed on the liquid crystal display portion 31, and then enters the smoke printing layer 25 through the transparent resin layer 4. The illumination light which has passed through the smoke printing layer 25 passes through the transparent substrate 21, and then passes through the front first matte printing layer 22, and then becomes visible to the driver.

Also, the illumination light emitted from the first illumination unit 62 is not passed except for the portions of the characters and the figures, and the like, displayed in the liquid crystal display portion 31. Therefore, since a contrast is occurred between the illumination light passing through the dial plate 2 and the illumination light not passing, drivers can recognize the forms of the various kinds of vehicle information displayed on the liquid crystal display portion 31.

On the other hand, illumination light emitted from the third illumination unit 64 including a light emitting diode mounted on the front surface of the circuit board 6 passes through the white printing layer 26 forming the scale parts 101 and the indicator part 102, then passes through the transparent substrate 21, the first matte printing layer 22 and the second matte printing layer 23 of the front surface of the white printing layer 26, and is then emitted to the outside, so that the area of the scale parts 101 and the like is passed and illuminated to be visible.

Since the liquid crystal display portion 31 is not exposed to the outside, the step between the information displayed in the liquid crystal display portion 31 and the scale parts 101 and the like is small. Therefore, since the information displayed in the liquid crystal display portion 31 is visually recognized as being displayed in the dial plate 2, it is possible to produce a unanimous sense as the same surface of the speedometer 100 and the information display unit 200.

Next, how the liquid crystal panel 3 is seen when the first illumination unit 62 does not emit illumination light (in being turned off) will be described. By the smoke printing layer 25 placed on the front surface of the liquid crystal panel 3, when the first illumination unit 62 is turned off, the appearance of the liquid crystal display portion 31 and the black printing layer 24 of the dial plate 2 is set to be uniform. Therefore, when the first illumination unit 62 is turned off, since the liquid crystal display portion 31 is not conspicuous, it is possible to provide a secret feeling.

Next, how the liquid crystal panel 3 is seen when external light is incident on the front surface of the dial plate 2 will be described. Since the first matte printing layer 22 and the second matte printing layer 23 contain a matte material, the layers have fine unevenness and the front surface reflection is reduced when the external light is incident on the front surface of the dial plate 2. In this way, in the area of the black printing layer 24, the print step with the scale parts 101, and the like, and the operation and warning lamp 300 is made inconspicuous so that the visual quality of the external appearance with high merchantability can be provided.

Note, that in the region of the black printing layer 24, the phenomenon that the front surface becomes muddy white occurs due to diffusion of light when external light is strongly hit, but in the scale parts 101, and the like, the white printing layer 26 reflects light to increase the brightness, so that the contrast can be maintained even if the black printing layer 24 becomes muddy white and the brightness increases, visibility is thus ensured.

Further, since the black printing layer 24 is formed on the back surface of the transparent substrate 21, as compared with the case where the black printing layer 24 is formed on the front surface of the transparent substrate 21, the print step of the second opening portion 24a, the scale parts 101, etc., and the operation and warning lamp 300 can be made inconspicuous, so that it is possible to provide an appearance with high merchantability.

Further, since the haze value of the first matte printing layer 22 is set to be lower than that of the second matte printing layer 23, the degree of reduction in the front reflection becomes weaker than that in the second matte printing layer 23. In other words, in the liquid crystal display portion 31, it is possible to weaken the phenomenon that the front surface becomes muddy white by the diffusion of light when the external light is strongly incident, so that the contrast of the display of the liquid crystal display portion 31 can be reduced and visibility can be secured.

Further, the transparent resin layer 4 has a refractive index close to that of the transparent substrate 21 when the external light is incident on the front surface of the dial plate 2, so that the reflection generated at the interface between the dial plate 2 and the transparent resin layer 4 can be suppressed, the contrast of the display of the liquid crystal display portion 31 can be prevented from being reduced, and the visibility can be ensured.

Moreover, since the first matte printing layer 22 is smaller in bead diameter than the second matte printing layer 23, the fine unevenness is small, the blurred appearance of the outline of the characters and figures displayed on the liquid crystal display portion 31 due to the unevenness can be prevented, thereby making it possible to obtain an appearance with high merchantability.

Also, at the front surface side of the second opening portion 24a formed on the back surface of the transparent substrate 21, the transparent substrate 21, the first matte printing layer 22 on the front surface of the transparent substrate 21, the gradation portion 23b of the second matte printing layer 23 on the front surface of the first matte printing layer 22 are provided. By forming like this, thanks to the diffusion effect by the thickness of the transparent substrate 21, the diffusion effect of light by the beads of the first matte printing layer 22, the diffusion effect of the light by the beads of the second matte printing layer 23 and the blurring effect by the gradation portion 23b, the second opening portion 24a can be noticeable, and the visual quality of the external appearance with high merchantability can be provided.

Also, since the first matte printing layer 22 and the second matte printing layer 23 completely overlap, the step is small, also since there is the gradation portion 23b inside the first opening portion 23a, it is not a clear boundary, even if the haze of the first matte printing layer 22 and the second matte printing layer 23 are changed, it is possible to change the haze naturally without losing the flat feeling on the face of the dial plate 2, so that the visual quality of the external appearance with high merchantability can be provided.

Also, the frontmost surface of the transparent substrate 21 is covered with the first matte printing layer 22 and the second matte printing layer 23. That is, since it is protected by the beads having the high front surface hardness, the scratch resistance on the frontmost surface is improved, and the damage on the frontmost surface can be prevented at the time of manufacturing or assembling.

Although the display device 1 of the present invention has been described by way of example with the configuration of the above-described embodiment, the present invention is not limited to this, and, in other configurations, various modifications and design changes are possible without departing from the scope of the present invention.

For example, although the ink containing the matte material is used for the first matte printing layer 22 and the second matte printing layer 23, even when a glossy ink containing no matte material is used, it is possible to provide a flat feeling on the surface of the dial plate 2 by forming in the same manner as described above. However, if it is formed in such a manner, since there is a risk that the front reflection becomes strong, and the visibility may deteriorate when external light is incident, it is necessary to take into consideration the reflection reduction such as adjusting the angle of the surface of the dial plate 2 relative to the driver.

Also, although the black printing layer 24 is formed on the back surface side of the transparent substrate 21, it may be provided between the front surface of the transparent substrate 21 and the first matte printing layer 22. Also, although the smoke printing layer 25 is provided on the second opening portion 24a, it may be provided on the front surface of the transparent substrate 21. Further, the transparent substrate 21 may be a smoke material, and the smoke printing layer 25 may be omitted. Although the transparent resin layer 4 is filled with a gel-like material, an Optical Clear Adhesive (OCA) sheet may be attached to fill the gap.

Further, an optical sheet such as a prism sheet or a diffusion plate made of a thin plate transparent PC resin may be provided between the liquid crystal panel 2 and the circuit board 6.

### INDUSTRIAL APPLICABILITY

The present invention relates to a display device for a vehicle, and is applicable to, for example, a display device for a vehicle mounted on an automobile, a motorcycle, or a mobile body equipped with an agricultural machine or construction machine.

### DESCRIPTION OF REFERENCE NUMERALS

2 dial plate

21 transparent substrate

22 first matte printing layer (first protective layer)

23 second matte printing layer (second protective layer)

23a first opening portion

23b gradation portion

24 black printing layer (light shielding layer)

24a second opening portion

25 smoke printing layer (colored layer)

3 liquid crystal panel

31 liquid crystal display portion (display portion)

1. A display device comprising:
a liquid crystal panel comprising a display portion; and
a dial plate placed on a front side of the liquid crystal panel,
wherein the dial plate comprises a transparent substrate, a first protective layer formed on a front surface of the transparent substrate, and a second protective layer formed on a front surface of the first protective layer, and
wherein the second protective layer of the dial plate comprises a first opening portion at a position corresponding to the display portion, and a gradation portion in which gradation becomes thinner toward an inside of the first opening portion.

2. The display device of the claim 1,
wherein the dial plate comprises a light shielding layer comprising a second opening portion at a position corresponding to the display portion on a back surface side of the first protective layer, and
wherein the gradation portion is formed across a position corresponding to the second opening portion.

3. The display device of claim 2, wherein the light shielding layer is formed on a back surface side of the transparent substrate.

4. The display device of claim 1, wherein the display device further comprises a colored layer at a position corresponding to the first opening portion.

5. The display device of claim 1, wherein a degree of haze of the first protective layer is lower than that of the second protective layer.
